(19) United States
(12) Patent Application Publication
(10) Pub. No.: US 2015/0215872 A1
(43) Pub. Date: Jul. 30, 2015

(54) PORTABLE COMMUNICATION DEVICE WITH SEPARATED A PROCESSING MODULE

(71) Applicant: Ming-Yuan WU, Taipei (TW)

(72) Inventor: Ming-Yuan WU, Taipei (TW)

(21) Appl. No.: 14/606,022

(22) Filed: Jan. 27, 2015

(30) Foreign Application Priority Data
Jan. 29, 2014 (TW) 103103376

(51) Int. Cl. H04W 52/02; H04M 19/08; H04M 1/725

(52) U.S. Cl. CPC H04W 52/0261; H04M 1/7253; H04M 19/08

(57) ABSTRACT

A portable communication device includes a processing module and a main body. The processing module has a SIM card processing element and a battery element and communicates over wireless with the main body. The main body includes a power supply module, a display element, a wireless receiving/transmitting element and an interface element. The processing module is designed to be separated from the main body to make the main body be lighter and thinner with high processing speed and better performance. Moreover, the processing module may include an electric socket to receive charged power. Therefore, the battery endurance of the portable communication device is enhanced to improve convenience of use.

### BACKGROUND OF THE INVENTION

1. Field of Invention

The present invention relates to a portable communication device, and more particularly, but not exclusively to portable communication device with separated a processing module to achieve high processing speed and better performance.

2. Related Art

Continued advancements in telecommunication technologies have made mobile phones, smartphones and other portable communication devices very popular. And the mobile phones is more powerful, diverse, but at the same time its power consumption is more. For example, such as GPS system, playing video or audio, map application or other entertainment APP.

To charge the power of the phones, the user may use the charger device. The users have to charge the batteries of the portable communication devices before the power of the battery in use going out, and have to bring a plurality of batteries for long time using. It is very inconvenient.

To solve the inconvenience mentioned above, the power banks are invented. The users only have to charge the power bank then connect the portable communication devices to the power bank to obtain power outdoor. The users will not worry about forgetting to charge the batteries of the portable communication devices or bring a plurality of batteries.

Please refer to FIG. 1, the conventional power bank device 2 is connected to the portable communication device 1 by a connecting cable 21 for charging. It is inconvenient for use. Therefore, there is a need to enhance the battery endurance of the portable communication device to improve convenience of use.

### SUMMARY OF THE INVENTION

The present invention overcomes the above-described and other problems and disadvantages in the prior art by providing a portable communication device to achieve high processing speed and better performance.

An object of the present invention is to provide a portable communication device to enhance the battery endurance of the portable communication device to improve convenience of use.

Accordingly, the present invention provides a portable communication device, including a main body and a processing module. The processing module is wirelessly communicated with the main body without physical connection. The main body may includes a wireless receiving/transmitting element, a display element, and an audio/video interface element. The wireless receiving/transmitting element is adapted to receive and transmit data to the processing module. The processing module is used to process the data. Therefore, the main body is lighter and thinner with high processing speed, better performance and low power consumption. The processing module is chargeable to enhance the battery endurance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is schematic view of the conventional portable communication device combined with a power bank device;

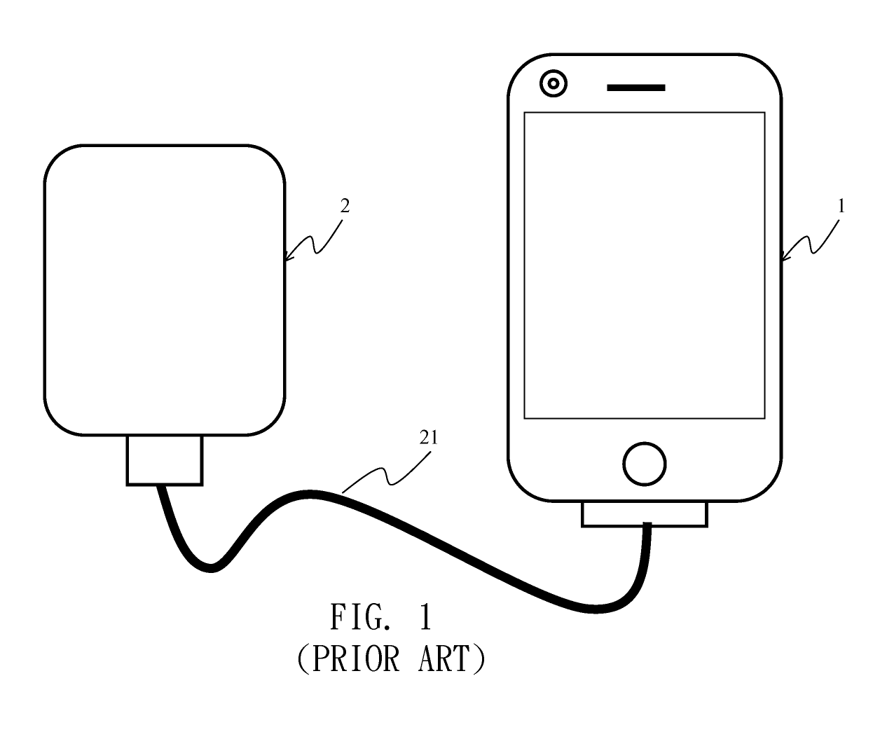

FIG. 2 is schematic view of the portable communication device of the present invention;

FIG. 3 is schematic view of the main body according to the portable communication device of the present invention;

FIG. 4 is schematic view of the processing module according to the portable communication device of the present invention; and

FIGS. 5A and 5B are perspective views of the the portable communication device of the preferred embodiment combined with connecting plug of the present invention.

### DETAILED DESCRIPTION OF THE INVENTION

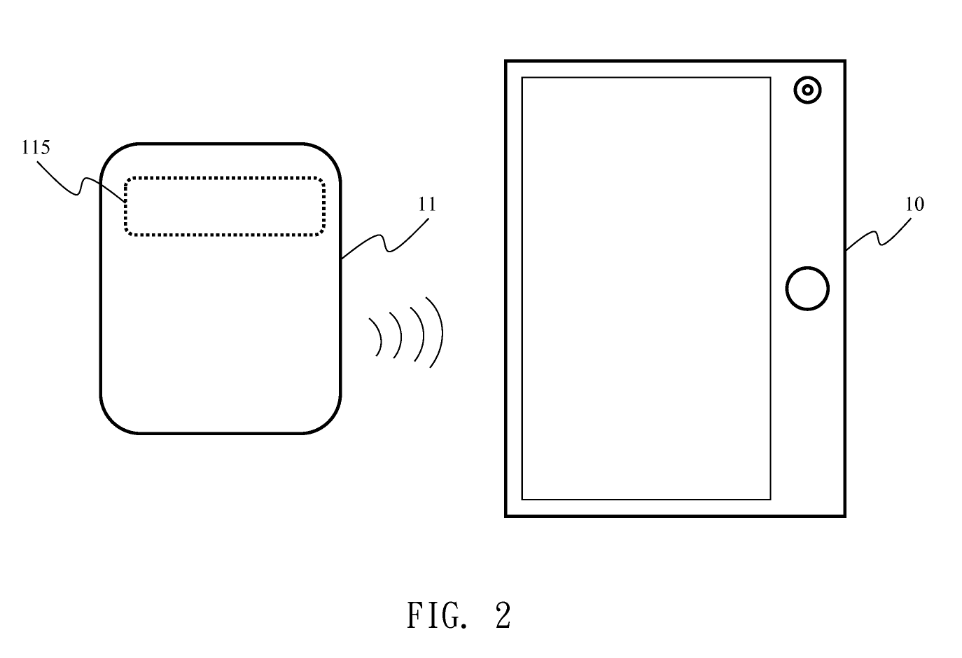

Please refer to FIG. 2, this invention provides a portable communication device including a main body 10 and a processing module 11. The processing module 11 is wirelessly communicated with the main body 10 to transmit the data without physical connection. By the split type device, the main body 10 is lighter and thinner.

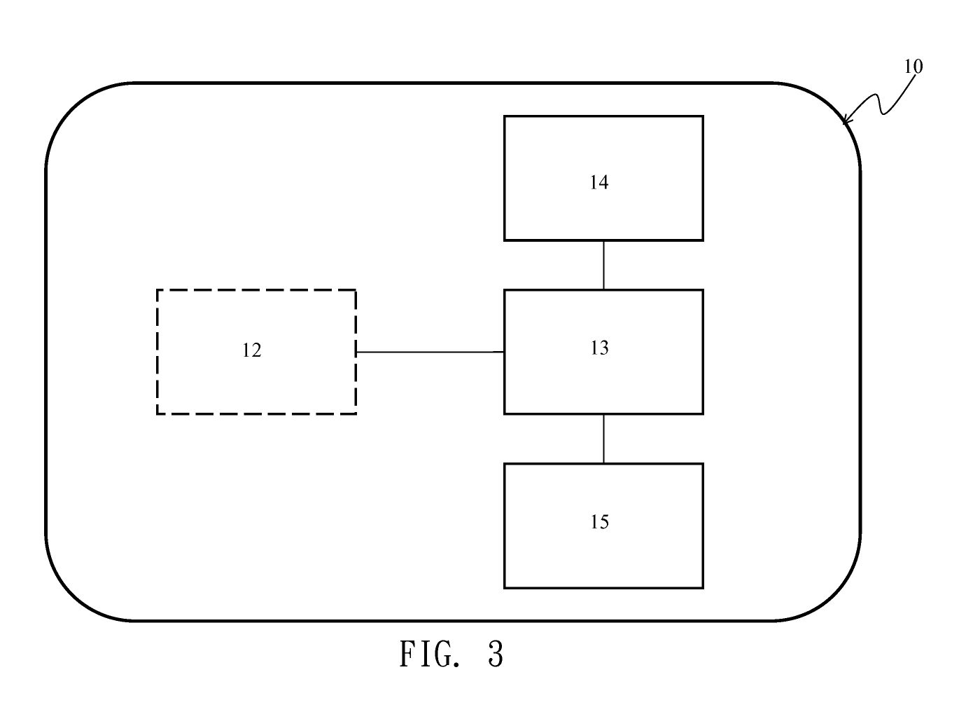

Please refer to FIG. 3, the main body 10 may includes a wireless receiving/transmitting element 14, a display element 15, a power supply module 12 and an audio/video interface element 15. The power supply module 12 is connected to the wireless receiving/transmitting element 14 and supplies to each elements of the main body 10. The wireless receiving/transmitting element 14 is adapted to receive the data from the processing module 11 and transmit the data to the processing module 11. The display element 13 is connected to the wireless receiving/transmitting element 14 to display the data. The audio/video interface element 15 is connected to the wireless receiving/transmitting element 14 to receive and transmit audio/video data from/to users. The audio/video interface element 15 may include a speaker, a microphone, a camera, and an earphone socket. The main body 10 may have other connection ports to connect to the processing module 11 to transfer data or charge.

Therefore, by this split design, the main body 10 is served only as a display to show the image and transfer audio/video data. The main body 10 is lighter and thinner with high processing speed, better performance and low power consumption. Smaller power supply module 12 is enough.

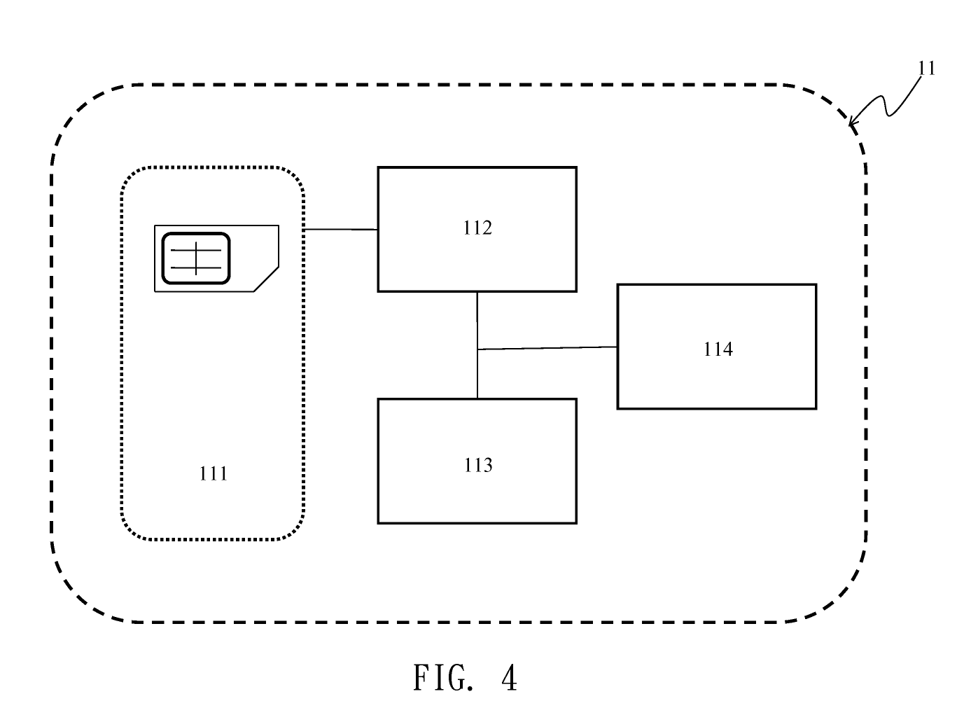

Please refer to FIG. 4, the processing module 11 includes at least one slot 111, a processing element 112, a battery element 114 and a wireless communication element 113. The slot 111 is used to receive a Subscriber Identity Module (SIM) card. The processing element 112 is connected to the wireless communication element 113 to process the data. The wireless communication element 113 is adapted to receive and transmit the data from and to the main body 10, such as coming calls, voice data, images messages and etc. The battery element 11 is connected to the processing element 112 and supplies to each elements of the processing module 11.

When the user operate the main body 10 of the portable communication device, the data is transmitted to the processing module 11 by the wireless receiving/transmitting element 14. The wireless communication element 113 receives the data and the processing element 112 would process the data. Then, the processed data would transfer back to the main body 10. Due to the processing module 11 is separated from the main body 10, the size of the processing module 11 will not be limited by the main body 10 as the conventional portable communication device. Therefore, the size of the processing module 11 may be designed to be larger to with good heat dissipation and better performance. Also, the battery element 114 may have larger capacity to enhance the endurance.

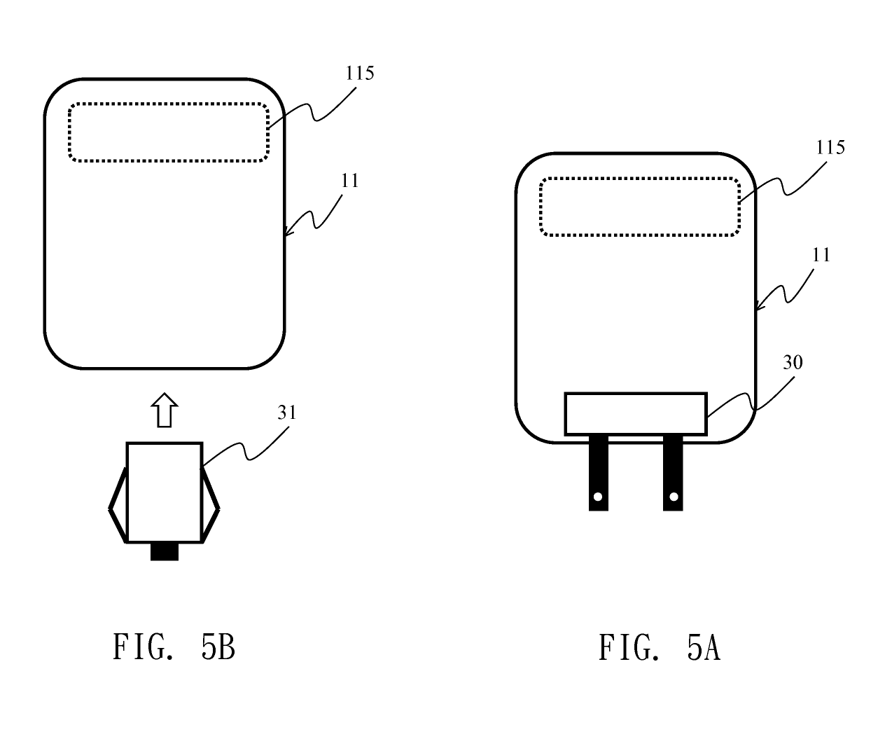

Please refer to FIGS. 5A and 5B, the processing module 11 may further include a connecting plug, such as an electric plug 30 and a car charger plug 31. The connecting plug may be foldable or replaceable and detachable. The processing module 11 may further include a connecting socket 115, such as network sockets, USB sockets, and etc., to transfer data, be charged or supply power. Therefore, the processing module 11 may also serve as a power bank device.

Accordingly, the present invention provides a novel split type portable communication device. The main body 10 is lighter and thinner with high processing speed, better performance and low power consumption, due to the processing module is separated. Moreover, the display may be designed as a transparent panel, which can be watched by both sides. And the both sides of the main body 10 have cameras. Therefore, the multiple party calls are achieved. Also, this display may be integrated with the windshield screens of the vehicle to serve as a HUD, head up display.

Accordingly, the present invention provides an outdoor LED lighting device which has good characteristics of thermal dissipation and waterproof. The outdoor LED lighting device can also have a prolonged service life and decreased light fade. Also, the outdoor LED lighting device has simplified structure. The light materials, such as plastic or aluminum, may be used to reduce the material costs and to mass-produce easily. The modular design of the outdoor LED lighting device eases maintenance and tends to lower costs of maintenance as a failed light emitting module, or a driver module is easy to replace and is less expensive to replace than replacement of the entire lamp.

The outdoor LED lighting device may be installed in a housing of the conventional outdoor lamp without having to discard the whole set of the conventional outdoor lamp, thus eliminating the unnecessary waste, in achieving cost-effectiveness and environment protection. Also, the outdoor LED lighting device may be used as a street light alone without being disposed the conventional housing. The waterproof structure is applied in the driver module, between the connecting module and the connecting base, between the casing and the lamp cover, and between the connecting base and the lamp socket of the conventional outdoor lamp. The whole outdoor LED lighting device has excellent waterproof effect. Therefore, the outdoor LED lighting device still works well after being exposed to outside for a long period of time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable communication device, comprising a main body and a processing module, the processing module is wirelessly communicated with the main body without physical connection.

2. The portable communication device of claim 1, wherein the main body comprising:
a wireless receiving/transmitting element, adapted to receive and transmit data to the processing module;
a display element, connected to the wireless receiving/transmitting element to display the data; and
an audio/video interface element, connected to the wireless receiving/transmitting element to receive and transmit audio/video data to users.

3. The portable communication device of claim 2, wherein the main body further comprising a power supply module, connected to the wireless receiving/transmitting element and supplying to the main body.

4. The portable communication device of claim 2, wherein the audio/video interface element includes a speaker and a microphone.

5. The portable communication device of claim 2, wherein the audio/video interface element includes a camera.

6. The portable communication device of claim 1, wherein the processing module comprising:
at least one slot, for receiving a Subscriber Identity Module (SIM) card;
a processing element, adapted to process data; and
a battery element, connected to the processing element and supplying to the processing module.

7. The portable communication device of claim 6, wherein the processing module further comprising a wireless communication element, adapted to receive and transmit the data.

8. The portable communication device of claim 1, wherein the processing module further comprising a connecting socket.

9. The portable communication device of claim 1, wherein the processing module further comprising a connecting plug.

10. The portable communication device of claim 9, wherein the connecting plug includes an electric plug and a car charger plug.
